(19) United States
(12) Patent Application Publication
(10) Pub. No.: US 2006/0068765 A1
(43) Pub. Date: Mar. 30, 2006

(54) Method and system of updating a function value on a subscriber unit and a network

(75) Inventor: Jorge L. Perdomo, Boca Raton, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/955,888

(22) Filed: Sep. 30, 2004

(51) Int. Cl. H04M 3/00

(52) U.S. Cl. 455/412.2

(57) ABSTRACT

In a wireless subscriber unit (26) having a receiver (36) for receiving a message (38) sent from a transmission source (21), a transmitter (60) for sending a change notification message (28) to the transmission source, and a function key (52) which operates using a function value (50), a method (100) for updating (108 or 114) the function value includes the steps of operating the function key using a first function value and sending (111 or 118) the change notification message to the transmission source. The method can further include the steps of substituting a second function value for the first function value in response to receiving a message, communicating confirmation of the substitution of the second function value for the first function value from the wireless subscriber unit to the transmission source, and operating the function key using the second function value.

### FIELD OF THE INVENTION

This invention relates generally to wireless subscriber units, and more particularly to wireless subscriber units which contain at least one function key.

### BACKGROUND OF THE INVENTION

Historically, wireless subscriber units have had the ability to receive a message, and perform standard functions in response to the message receipt such as storing the message, displaying the message, or alerting the user of receipt of the message.

Today's wireless subscriber units are no longer restricted to just these standard functions. Manufacturers of wireless subscriber units are now adding applications to provide value added services such as calculator functions, stock market analysis, financial analysis, and tax calculation. The wireless subscriber units perform calculations within these applications using function values accessed when a function key has been activated.

One drawback of today's wireless subscriber units is the inability to modify the function value based on a received message or a network affiliation. Furthermore, no existing wireless subscriber unit enables the deletion of a function or disables a function once the device notifies the network that it will out of a predetermined network. As wireless applications become more prevalent in the industry, and become more critical as business tools, the requirement for such a capability increases.

### SUMMARY OF THE INVENTION

In accordance with a first embodiment of the present invention in a wireless communication system in which a wireless subscriber unit has a receiver for receiving a message sent from a transmission source, an transmitter, and a function key which operates using a function value, the transmission source including a receiver for receiving a change notification message, a method for updating the function value can include the steps of operating the function key using a first function value, communicating the change notification message to the transmission source, and the transmission source responding thereto by sending a message to the wireless subscriber unit. The method can further include the step of substituting a second function value for the first function value by the wireless subscriber unit, communicating confirmation of the substitution of the second function value for the first function value from the wireless subscriber unit to the transmission source, and operating the function key using the second function value.

In a second embodiment of the present invention in a wireless subscriber unit having a receiver for receiving a message sent from a transmission source, a transmitter for sending a change notification message to the transmission source, and a function key which operates using a function value, a method for updating the function value can include the steps of operating the function key using a first function value and sending the change notification message to the transmission source. The method can further include the steps of substituting a second function value for the first function value in response to receiving a message, communicating confirmation of the substitution of the second function value for the first function value from the wireless subscriber unit to the transmission source, and operating the function key using the second function value.

In yet a third embodiment of the present invention, a wireless subscriber unit for receiving a message sent from a transmission source can include a receiver for receiving the message including a second function value, wherein the second function value is determined by the transmission source, a message processor coupled to the receiver for processing the received message, and a memory coupled to the message processor for storing a first function value in a memory location. The wireless subscriber unit can further include a function key executing an operation using the first function value stored in the memory location, a controller coupled to the function key for replacing the first function value stored in the memory location with the second function value in response to receiving the message including the second function value from the transmission source, and a network affiliation sensor detecting a predetermined network and for providing a signal enabling at least a portion of the second function value. The wireless subscriber unit can further include a transmitter for sending a change notification message to the transmission source. Note, the transmission source notifies the wireless subscriber unit of the second function value and the second function value is sent as a message (or an attachment to a message) from the transmission source to the wireless subscriber unit. Further note that the wireless subscriber unit can have a network affiliation detectable by the network affiliation sensor, and the change notification message is communicated in response to a change in a network affiliation of the wireless subscriber unit. The second function value can be at least partially disabled when the network affiliation sensor fails to detect the predetermined network and furthermore data can be removed from the wireless subscriber and from the predetermined network when the network affiliation sensor fails to detect the predetermined network. The wireless subscriber can send notification that the second function value has been removed from the wireless subscriber unit and the predetermined network after validating that the wireless subscriber unit is no longer in the predetermined network. Alternatively, the second function value can be at least partially enabled when the network affiliation sensor detects the predetermined network.

In today's environment most handheld devices are capable of receiving updated functions to perform a task. Embodiments herein can have the function updated into the device when the device sends a notification. This notification can be sent to a local network once the device is within network parameters. Once the device has received the function, the function can be used to perform a task. In one embodiment, the function will be deleted from the device as well as the network once the validation of the device is no longer in the authorized or predetermined area network. The device can notify the network before it is out of a local network. Such notification can allow the device to have limited function capability once outside of a localized or predetermined network. For example, embodiments herein can be used for in-store coupons and offers given to customers in a local area network based on a network affiliation.

### BRIEF DESCRIPTION OF THE DRAWINGS

FIG. 1 is an electrical block diagram of a wireless communication system in accordance with an embodiment of the present invention;

FIG. 2 is an electrical block diagram of a wireless subscriber unit that operates within the wireless communication system of FIG. 1 in accordance with an embodiment of the present invention;

FIG. 3 is a flow chart illustrating the operation of an embodiment in accordance with the present invention;

FIG. 4 is a flow chart illustrating more detail of the operation shown in FIG. 3.

FIG. 5 is a flow chart illustrating the operation of another embodiment in accordance with the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

In accordance with one embodiment, a method disclosed herein can enable a function key such as a soft-key to be limited by the network affiliation or service restrictions applied to the message. The function key can update the value/functionality of the soft-key for example.

In today's environment most handheld devices are capable of receiving updated functions to perform a task. Embodiments of the invention can enable a function to be updated in the device when the device sends a notification or a timed response to a network or receives a service indication. This notification can be sent to a local network or central service location once the device is within network parameters or a predefined area associated with a network. Once the device has received the message, the function can be used to perform the task received or granted by a server or control station. This function can be deleted from the device and the network can be updated based on any changes to the function key found on the device.

Note, information can be sent from the device back to a server, network, or controller enabling the server, network or controller to control or limit the functionality or restrict the operation of the soft-key function on the device and optionally track the location of the device. For example, one use case can be a ringtone that is freely downloaded at a specific location associated with a network (e.g., a sporting event). The ringtone can then be removed or restricted with the option to purchase or activate for a fee once the user is away from the network (or the associated event). In a second use case, a full version of a game can be freely downloaded while the user is at an entertainment venue (e.g., Boomers or Dave & Buster's). The game is then removed or restricted with the option to purchase or activate for a fee once the user leaves the premises associated with a particular network.

Embodiment herein can allow a server or control station to monitor or receive confirmation of available function on the wireless device. Once the validation of the function is no longer found or limited on the device, the server or control station can also be updated as to the network or location the device is in or was in. Optionally using commonly used location detection means, the device can notify the network before or once it has been deemed in an area for a period of time that it is or will be out of the local network or central service location. The location detection means can allow the automatically updated function in the device to have limited function capability once outside of a localized network or central service location.

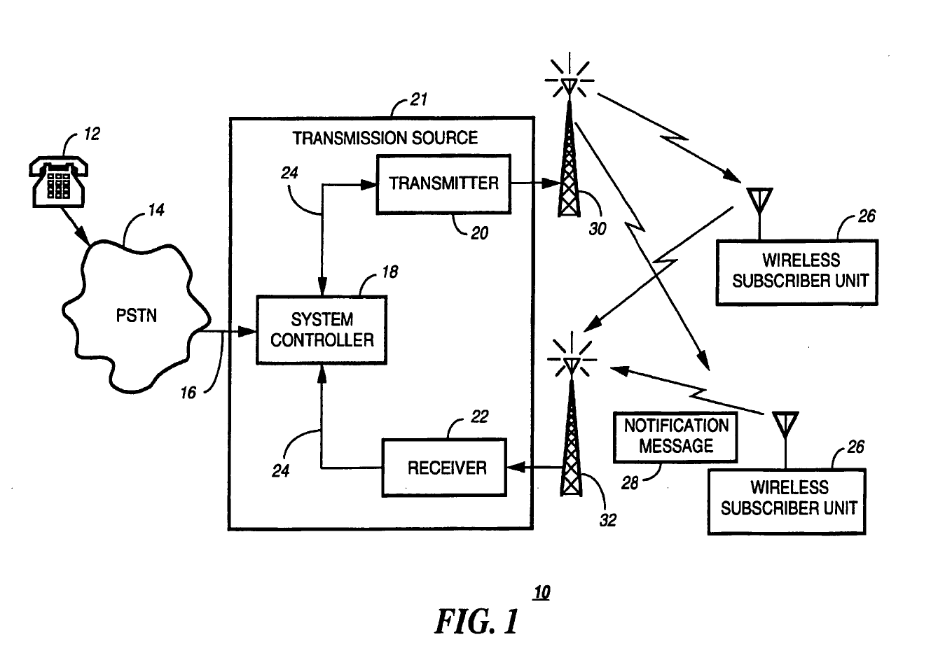

Referring to FIG. 1, an electrical block diagram of a wireless communication system 10 is shown in accordance with an embodiment of the present invention. The wireless communication system 10 comprises a message input device, such as a conventional telephone 12 connected through a conventional switched telephone network (PSTN) 14 by conventional telephone links 16 to a system controller 18. The system controller 18 oversees the operation of at least one transmitter 20 and, in one embodiment, at least one receiver 22, through one or more communication links 24, which typically are twisted pair telephone wires, and additionally can include RF, microwave, or other high quality audio communication links. The system controller 18 encodes and decodes inbound and outbound telephone addresses into formats that are compatible with land line message switch computers. The system controller 18 also functions to digitally encode and schedule outbound messages, which can include such information as alphanumeric messages for transmission by the transmitter 20 to a plurality of wireless subscriber units 26 on a set of outbound radio frequency (RF) channels. The system controller 18 further functions to decode inbound messages, including unsolicited and response messages, such as a change notification message 28 received by the receiver 22 from a wireless subscriber unit 26. A transmission source 21 comprises the system controller 18 in combination with the transmitter 20 and the receiver 22.

Examples of inbound messages are acknowledgments and designated response messages. Designated response messages are communicated in the inbound channel in portions named data units. An acknowledgment is a response to an outbound message initiated at the system controller 18. An example of an outbound alphanumeric message intended for a wireless subscriber unit 26 is a page message entered from the telephone 12. The outbound messages are included in outbound radio signals transmitted from a conventional antenna 30 coupled to the transmitter 20. The inbound messages are included in inbound radio signals received by a conventional antenna 32 coupled to the receiver 22.

It will be appreciated that the wireless subscriber units 26 may be, for example, one and two way pagers, conventional mobile cellular telephones, conventional mobile radios, conventional mobile cellular telephones or trunked mobile radios or any other combination thereof. In the following description, the term wireless subscriber unit 26 will be used to refer to any of the wireless subscriber units listed above. Each of the wireless subscriber units 26 assigned for use in the wireless communication system 10 has an address assigned thereto which is a unique selective call address in the wireless communication system 10. The address enables the transmission of a message from the system controller 18 only to the addressed wireless subscriber unit 26, and identifies messages and responses received at the system controller 18 from the wireless subscriber unit 26. Furthermore, each of one or more of the wireless subscriber units 26 also can have a unique telephone number assigned thereto which is entered by a user sending a message via the PSTN 14, to identify the intended wireless subscriber unit 26. The telephone number is unique within the PSTN 14. A list of the assigned addresses and correlated telephone numbers for the wireless subscriber units 26 is stored in the system controller 18 in the form of a subscriber data base.

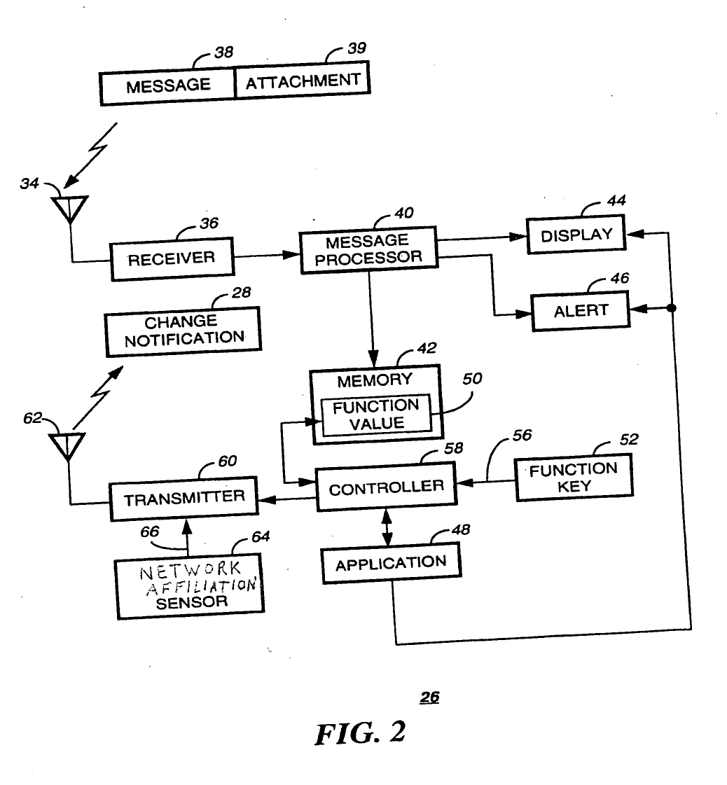

FIG. 2 is an electrical block diagram of a wireless subscriber unit 26 that operates within the wireless communication system 10 of FIG. 1. The wireless subscriber unit 26 comprises an antenna 34 for intercepting RF signals from the wireless communication system 10. The antenna 34 is coupled to a receiver 36 employing conventional demodulation techniques for receiving the communication signals transmitted by the wireless communication system 10 such as a message 38. Included in a communication signal of a message 38 may also be an attachment 39 containing further required information for value added services utilization, for example. Radio frequency signals received by the receiver 36 produce demodulated information, which is coupled to a message processor 40 for processing received messages, and, optionally, attachments to messages.

To perform the functions of the wireless subscriber unit 26, a message processor 40 is coupled to a memory 42 including a random access memory (RAM), a read-only memory (ROM), and an electrically erasable programmable read-only memory (EEPROM). The message processor 40 can be similar to the M68HC11 micro-controller manufactured by Motorola, Inc. It should be appreciated that other similar processors can be utilized for the message processor 40, and that additional processors of the same or alternative type can be added as required to handle the processing requirements of the message processor 40.

The message processor 40 decodes an address in the demodulated data of the received message 38, compares the decoded address with one or more addresses stored in the memory 42, and when a match is detected, proceeds to process the remaining portion of the message 38 (and, optionally, attachment 39). Once the message processor 40 has processed the message 38 (and any attachment 39), it stores the message 38 (and the attachment 39) in the memory 42, and the message processor 40 can send a command to the display 44 and/or alert 46 to notify the user that a message has been received.

In one embodiment, the wireless subscriber unit 26 includes at least one application 48 to provide a value added service such as calculator functions, stock market analysis, financial analysis, or tax calculation. The wireless subscriber unit 26 performs calculations within this application 48 using a function value 50 stored in memory 42 and accessed when a function key 52 has been activated. The function key 52, responsive to a user input, such as a user depressing the function key button, initiates an input signal 56 to a controller 58. The controller 58, in response to the input signal 56, accesses the function value 50 stored in memory 42 and provides this function value 50 to the application 48 for use in operation of the application 48. The controller 58 can be similar to the M68HC11 micro-controller manufactured by Motorola, Inc. It will be appreciated that other similar processors can be utilized for the controller 58, and that additional processors of the same or alternative type can be added as required to handle the processing requirements of the controller 58.

The addition of a controller to update a function value for an application expands the value and usefulness of the wireless subscriber unit for the end user. For example, if the end user was an international traveler, the application 48 was an expense statement, and the function value 50 was the current exchange rate to be used in operation of the expense statement, having automatic updates of this exchange rate would greatly simplify the traveler's activities.

In one embodiment of the invention, the wireless subscriber unit 26 includes a transmitter 60 coupled to a transmit antenna 62 capable of sending a change notification message 28 to the wireless communication system 10. The transmitter 60 is coupled to a network affiliation sensor 64 which senses the network affiliation (and optionally, but not necessarily location) of the wireless subscriber unit 26. When the network affiliation sensor 64 senses a change in affiliation of the wireless subscriber unit 26, it sends a signal 66 to the transmitter 60 for initiation of a change notification message 28. Referring briefly to FIG. 1, the change notification message 28 is received by the receive antenna 32, which is coupled to the receiver 22, which then decodes the information and sends the data through communication link 24 to the system controller 18. In response to receipt of a change notification message 28, the system controller 18 identifies a corresponding new function value and sends this function value to the wireless subscriber unit 26. Upon receipt of the new function value by the wireless subscriber unit 26, the new function value is stored in memory 42 replacing the current function value. The next time the function key is activated, the controller 58 will access memory 42 to retrieve the new function value, and use the new function value in operation of the application 48.

The ability to change the function value 50 based on a notification of change in network affiliation expands the value of wireless subscriber units 26 with built-in applications by allowing real-time calculations without requiring a manual function value change by the end user. For example, if the application 48 was a state sales tax calculator, as a wireless subscriber unit 26 moved from one state to another, the sales tax percentage (function value 50) would be updated without any manual user input required. Thus, whenever the user operated the function key 52 to perform the operation of the application 48, the correct sales tax percentage would be calculated. In another example, a coupon used in one store of a chain store having participating franchisees in various portions of the country can authorize use of a coupon based on an affiliation with a particular network using a predetermined authorization code for the function value. Non-participating franchisees may not be part of the affiliated network or alternatively can be part of the affiliated network and yet not be able to provide the predetermined authorization code.

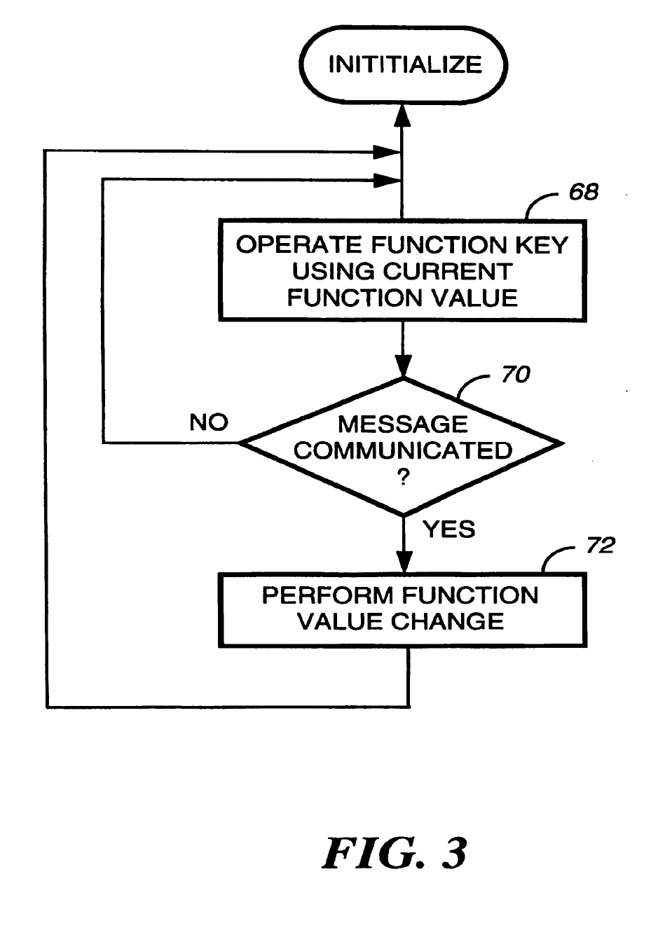

FIG. 3 is a flow chart illustrating how the controller 58 is programmed to operate in accordance with the invention. At step 68, the function key 52 is operated using a current function value. Next, in step 70, the system checks for communication of a message. If no message has been communicated, the process returns to the beginning, operating step 68 using the same function value. If a message has been communicated, a function value change is performed in step 72. The process then returns to the beginning, operating step 68 using the new function value.

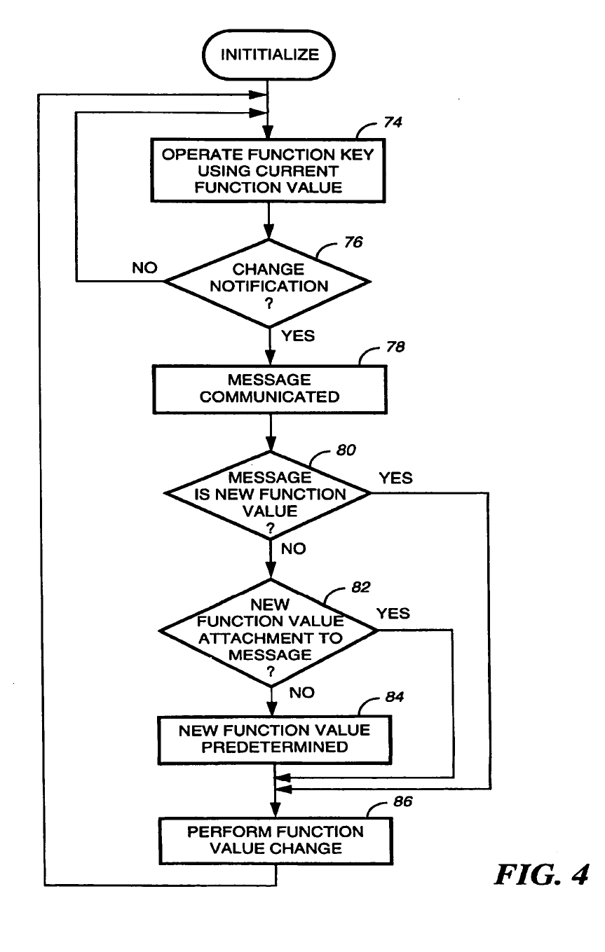

FIG. 4 is a flow chart illustrating more detail of the operation of the wireless communication system shown in FIG. 1. In step 74, the function key 52 of the wireless subscriber unit 26 is operated using the function value 50 stored in memory 42. Next, in step 76, the system verifies whether or not a change notification message 28 has been sent from the wireless subscriber unit 26 to the transmission source 21. If a change notification message 28 has not been sent, the process returns to the beginning, operating step 74 using the same function value. If a change notification message 28 has been sent, a message 38 is communicated from the transmission source 21 to the wireless subscriber unit 26 (step 78). Next, in step 80, the controller 58 of the wireless subscriber unit 26 checks if the message 38 is a new function value. If the message 38 is a new function value, a function value change is performed by the controller 58 (step 86), and the process returns to the beginning, operating step 74 using the new function value. If the message 38 is not a new function value, the controller 58 of the wireless subscriber unit 26 checks if a new function value is an attachment 39 to the message 38 (step 82). If anew function value is an attachment to the message 38, a function value change is performed by the controller 58 (step 86), and the process returns to the beginning, operating step 74 using the new function value. If a new function value is not an attachment to the message 38, the controller 58 may optionally use a predetermined algorithm programmed into the controller 58 to create a new function value (step 84). This predetermined algorithm may be, for example, a database calculation based on a factor such as a date, or a command to continue using the most recent function value. Next, a function value change is performed by the controller 58 (step 86), and the process returns to the beginning, operating step 74 using the new function value.

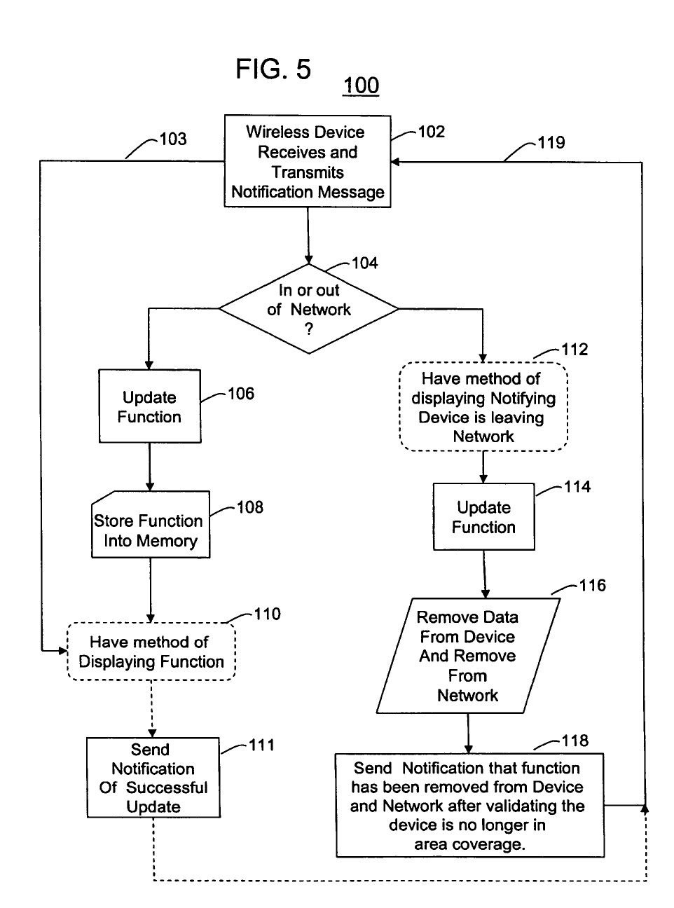

Referring to FIG. 5, a flow chart 100 illustrates a method of operating the wireless communication system shown in FIG. 1. At block 102 the wireless subscriber device either receives (119) a message from a server, network, or controller or sends (103) a notification message to the server, network, or controller. At decision block 104, a determination is made whether the wireless subscriber device is affiliated (or in or out) of a particular network. If the wireless subscriber device is affiliated with the particular network, then a function or a function value can be updated at step 106 and stored at step 108. Optionally, the function can be displayed at step 110. Optionally, the method 100 can further provide notification of a successful update of the function or function value at step 111. If the wireless subscriber device is not affiliated (or loses affiliation) with the particular network, then the device can optionally display a notification that the device is leaving the particular network at step 112. At step 114, the function or function value can be updated. Furthermore, at step 116 data can be removed from the device and from the network. Notification of the removal of data (or of a certain function or function value) can be provided to the server, network or controller at step 118 after validation that the wireless subscriber device is no longer affiliated with the predetermined network.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. In a wireless communication system in which a wireless subscriber unit has a receiver for receiving a message sent from a transmission source, an transmitter, and a function key which operates using a function value, the transmission source including a receiver for receiving a change notification message, a method for updating the function value, comprising the steps of:
operating the function key using a first function value;
communicating the change notification message to the transmission source, and the transmission source responding thereto by sending a message to the wireless subscriber unit;
the wireless subscriber unit substituting a second function value for the first function value;
communicating confirmation of the substitution of the second function value for the first function value from the wireless subscriber unit to the transmission source; and
operating the function key using the second function value.

2. The method as recited in claim 1, wherein:
the transmission source notifies the wireless subscriber unit of the second function value.

3. The method as recited in claim 1, wherein: the second function value is sent as a message from the transmission source to the wireless subscriber unit.

4. The method as recited in claim 1, wherein the wireless subscriber unit can join a predetermined network affiliation, and wherein a change notification message is communicated in response to a change in a network affiliation of the wireless subscriber unit.

5. The method of claim 4, wherein the second function value is at least partially disabled when the wireless subscriber unit fails to detect the predetermined network.

6. The wireless subscriber unit of claim 4, wherein the second function value is at least partially enabled when the wireless subscriber unit detects the predetermined network.

7. The wireless subscriber unit of claim 4, wherein data is removed from the wireless subscriber and from the predetermined network when the wireless subscriber unit fails to detect the predetermined network.

8. The wireless subscriber unit of claim 7, wherein the wireless subscriber sends notification that the second function value has been removed from the wireless subscriber unit and the predetermined network after validating that the wireless subscriber unit is no longer in the predetermined network.

9. In a wireless subscriber unit having a receiver for receiving a message sent from a transmission source, a transmitter for sending a change notification message to the transmission source, and a function key which operates using a function value, a method for updating the function value, comprising the steps of:
operating the function key using a first function value;
sending the change notification message to the transmission source;
substituting a second function value for the first function value in response to receiving a message;
communicating confirmation of the substitution of the second function value for the first function value from the wireless subscriber unit to the transmission source; and
operating the function key using the second function value.

10. The method as recited in claim 9, wherein the wireless subscriber unit has a network affiliation, and wherein the change notification message is sent in response to a change in a network affiliation of the wireless subscriber unit.

11. A wireless subscriber unit for receiving a message sent from a transmission source, comprises:
a receiver for receiving the message including a second function value, wherein the second function value is determined by the transmission source;
a message processor coupled to the receiver for processing the received message;
a memory coupled to the message processor for storing a first function value in a memory location;
a function key executing an operation using the first function value stored in the memory location;
a controller, coupled to the function key, for replacing the first function value stored in the memory location with the second function value in response to receiving the message including the second function value from the transmission source; and
a network affiliation sensor detecting a predetermined network and for providing a signal enabling at least a portion of the second function value.

12. The wireless subscriber unit of claim 11, further comprising a transmitter for sending a change notification message to the transmission source.

13. The wireless subscriber unit of claim 11, wherein the transmission source notifies the wireless subscriber unit of the second function value.

14. The wireless subscriber unit as recited in claim 11, wherein: the second function value is sent as a message from the transmission source to the wireless subscriber unit.

15. The wireless subscriber unit as recited in claim 11, wherein: the second function value is sent from the transmission source to the wireless subscriber unit as an attachment to a message.

16. The wireless subscriber unit as recited in claim 11, wherein the wireless subscriber unit has a network affiliation detectable by the network affiliation sensor, and wherein the change notification message is communicated in response to a change in a network affiliation of the wireless subscriber unit.

17. The wireless subscriber unit of claim 16, wherein the second function value is at least partially disabled when the network affiliation sensor fails to detect the predetermined network.

18. The wireless subscriber unit of claim 16, wherein the second function value is at least partially enabled when the network affiliation sensor detects the predetermined network.

19. The wireless subscriber unit of claim 16, wherein data is removed from the wireless subscriber and from the predetermined network when the network affiliation sensor fails to detect the predetermined network.

20. The wireless subscriber unit of claim 19, wherein the wireless subscriber sends notification that the second function value has been removed from the wireless subscriber unit and the predetermined network after validating that the wireless subscriber unit is no longer in the predetermined network.
